(19) United States
(12) Patent Application Publication
(10) Pub. No.: US 2011/0139822 A1
(43) Pub. Date: Jun. 16, 2011

(54) Soap Dispenser

(76) Inventor: Siu Wai Sam Siu, Guangzhou (CN)

(21) Appl. No.: 13/057,244

(22) PCT Filed: Jun. 26, 2009
(86) PCT No.: PCT/CN09/72471

§ 371 Date: Feb. 2, 2011

(30) Foreign Application Priority Data
Feb. 6, 2009 (HK) 09101093.5

(51) Int. Cl. B67D 7/84

(52) U.S. Cl. 222/173

(57) ABSTRACT

A liquid soap dispenser, comprises: a hollow housing combined by a replaceable liquid squeezing box and a bottom box; a liquid soap container disposed in the housing; a single-way valve mounted at the rear end of the liquid soap container; a nozzle connected with the front end of the liquid soap container; a liquid outlet valve disposed in the nozzle; wherein the liquid squeezing box has a frame or plate on which pattern or characters are printed; the liquid squeezing box is connected to the bottom box by screws, so that the liquid squeezing box is replaceable. The main purpose of present invention is to improve and enhance the appearance of the liquid soap dispenser. Moreover, by replacing the liquid squeezing box and utilizing the plate or frame to which a picture such as for advertising can be attached, the blank and unused front surface of the liquid squeezing box is turned into an advertising region which might bring more business opportunity and thereby the fortune.

### FIELD OF THE INVENTION

The present invention relates to a liquid soap dispenser used as consumer commodities, more particularly, to a liquid soap dispenser of which the pattern on a liquid squeezing box is replaceable.

### DESCRIPTION OF RELATED ART

The use of liquid soap dispenser in household, restaurant, hotel and other public site is well known in prior art, and they can be classified into two categories, i.e., manual type and electric sensing type. Generally, conventional liquid soap dispensers are simply designed to have only one color, hence the whole appearance of them is monotonous and toneless. Furthermore, the surface of the liquid squeezing box of conventional liquid soap dispensers which faces the users usually is unvarying, and in the meanwhile the liquid squeezing box cannot be replaced. As a result, a potential business opportunity which could have contributed to the growth of a marketing business is wasted for nothing.

As such, it should be appreciated that there is a need for an improved liquid soap dispenser which addresses above problems.

### SUMMARY OF THE INVENTION

In view of the disadvantages of being blank or toneless in appearance in the conventional liquid soap dispensers, the present invention provides a liquid soap dispenser of which the pattern on a liquid squeezing box is replaceable.

To attain this, the liquid soap dispenser according to an embodiment of present invention comprises: a hollow housing combined by a replaceable liquid squeezing box and a bottom box; a liquid soap container disposed in the housing; a single-way valve mounted at the rear end of the liquid soap container; a nozzle connected with the front end of the liquid soap container; a liquid outlet valve disposed in the nozzle; wherein the liquid squeezing box has a frame or plate on which pattern or characters are printed; the liquid squeezing box is connected to the bottom box by screws, so that the liquid squeezing box is replaceable.

The main object of present invention is to improve and enhance the appearance of the liquid soap dispenser. Moreover, by replacing the liquid squeezing box and utilizing the plate or frame to which a picture such as for advertising can be attached, the blank and unused front surface of the liquid squeezing box is turned into an advertising plaque which might bring more business opportunity and thereby the fortune.

It is a key aspect of present invention to provide the liquid squeezing box with a plate printed with pattern or picture or commercial advertisement materials, and the liquid squeezing box can be designed into various arcuate shapes, therefore, the appearance and the figure of the liquid soap dispenser will be enhanced. Such dispensers can be hanged on the wall of a bathroom of a restaurant or hotel to beautify the bathroom.

Besides, merchants can use the liquid soap dispenser of present invention to propagandize their merchandize or service. Since generally the liquid soap dispensers are used in toilet of shopping centers and other crowded public sites, the liquid soap dispensers are frequently used by the people, and these persons will notice the pattern or character or advertisement material on the liquid squeezing box when they press the liquid squeezing box to get the liquid soap. Then, these people might be impressed by the contents on the liquid squeezing box and become a customer of the business entity advertising on the dispenser.

Furthermore, the liquid squeezing box is removable, which means the owner of the dispenser can replace the old liquid squeezing box with a new one. In use, the new plate can be changed so as to correspond to the topic and atmosphere of different festival or anniversary. In this way, a new liquid squeezing box can bring novelty to the liquid soap dispenser and arouse interest to persons who see it for the first time. Further, it contributes to beautify the colors of the walls in the rest room in which the liquid soap dispenser is applied.

Preferably, the liquid soap container of the liquid soap dispenser has a smooth front face which is different from the back face thereof. Specifically, the front face is designed to be in the shape of an arch. With such design, the liquid soap container will receive a pressure smoothly when a user presses the liquid squeezing box, and the liquid soap will outflow under a small pressure. Furthermore, the back face of the liquid soap container is provided with grooves for fitting with two resting ridges provided inside the bottom box. The resting ridges are designed to hold the liquid soap container in the housing assembly steady, shakeless and the cooperation of the resting ridges and the ridges inside the liquid squeezing box can imitate the squeezing action by the fingers of a user from both sides and hence enabling uniform press on the liquid soap container.

The liquid soap container also is removable; accordingly, when the liquid soap is used up, a new liquid soap container can be fixed in the dispenser to replace the old one. The replacement operation is simple and convenient, especially when the liquid soap container is produced by the original manufacturer and thereby can fit with the resting ridges of the dispenser well.

At the mention of using the liquid soap dispenser according to present invention, renting it to a merchant is also feasible, on one hand, the owner of the dispenser can obtain an income of rent, on the other hand, the business entity getting the right to use the dispenser can propagandize or advertise for its merchandize or service with the dispenser. In this way, it brings forth profits both for the owner as the renting offer but also to the user of the liquid soap dispenser, which gives rise to a potential successful business and market. Therefore, the liquid soap dispenser of present invention can provide a potential big commercial use.

### BRIEF DESCRIPTION OF THE DRAWINGS

FIGS. 1 and 2 show a schematic view of the structure of the present invention.

FIG. 3 shows a schematic view of the front surface of the liquid soap container and other components of the liquid soap dispenser according to an embodiment of present invention.

FIG. 4 shows a schematic view of the back surface of the liquid soap container and other components of the dispenser illustrated in FIG. 2.

FIG. 5 shows the appearance of the dispenser according to an embodiment of present invention.

FIG. 6 shows a schematic view of the internal structure of the liquid squeezing box of the dispenser according to an embodiment of present invention.

FIG. 7 shows a schematic view of the internal structure of the bottom box of the dispenser according to an embodiment of present invention.

FIG. 8 shows the appearance of the bottom box of the dispenser according to an embodiment of present invention.

FIG. 9 shows the top view of the dispenser according to an embodiment of present invention while being arranged vertically for use.

FIG. 10 shows the bottom view of the dispenser according to an embodiment of present invention while being arranged vertically for use.

FIGS. 11a, 11b, 11c, and 11c show the schematic view of the liquid squeezing box of various arcuate designs.

FIGS. 12a, 12b and 12c show top view and sectional view of the silicon liquid outlet valve, the liquid outlet valve stabilizer and the nozzle used in an embodiment of present invention.

### DETAILED DESCRIPTION OF THE INVENTION

The embodiments of present invention will be described with reference to the attached figures.

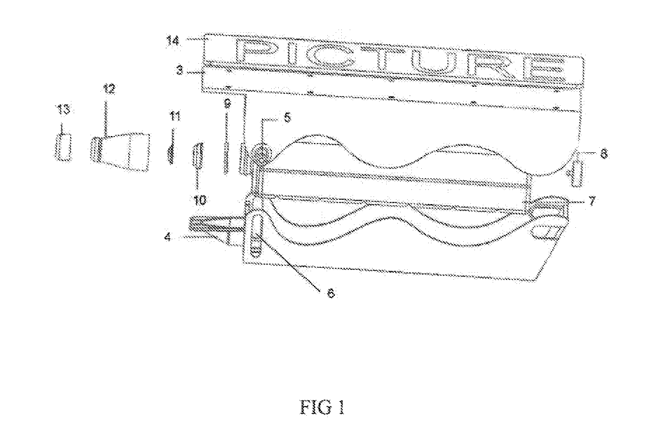

As illustrated in FIGS. 1-12, a liquid soap dispenser 1 according to an embodiment of the present invention, comprising: a hollow housing assembly 2 combined by a replaceable liquid squeezing box 3 and a bottom box 4; a liquid soap container 7 disposed inside the housing 2; a single-way valve 8 mounted at the rear end of the liquid soap container 7; a nozzle 12 connected with the front end of the liquid soap container 7; a liquid outlet valve 11 disposed in the nozzle. The liquid squeezing box 3 has a frame or plate 14 on which pattern or characters are printed; the liquid squeezing box 3 is connected to the bottom box 4 by screws, so that the liquid squeezing box 3 is replaceable.

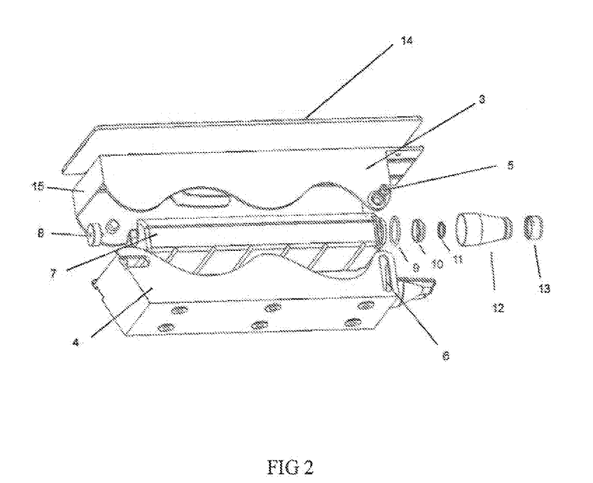

As shown in FIGS. 1 and 2, in the preferred example, the liquid soap dispenser 1 comprises: a hollow housing assembly 2 combined by a liquid squeezing box 3 and a bottom box 4, both of them are made of plastic and are molded into a cuboid shape with lateral sides formed with wavelike or arcuate edges. Two hexagonal screws 5 are used to connect and fix the liquid squeezing box 3 to two slots 6 of the bottom box 4. In an example, the liquid soap dispenser 1 further comprises: a plastic liquid soap container 7 disposed inside the housing assembly 2, a single-way valve 8 and a silicon O-ring 9 mounted at the rear end and front end of the liquid soap container 7 respectively, a plastic liquid outlet valve stabilizer 10, a silicon liquid outlet valve 11 disposed in a nozzle 12 connected with the liquid soap container 7, and a protection cap 13 mounted at the front end of the nozzle 12. At the rear end of the liquid squeezing box 3, a shield plate 15 is arranged to hide the liquid soap container 7 in the housing assembly 2.

In above embodiment, the component for carrying pattern/character or a picture 141 is a plate 14 attached to or fixed on the liquid squeezing box 3. However, present invention is not limited in this way, as an alternative, a frame into which a picture or photo can be inserted can be fixed on the liquid squeezing box 3.

As the small membrane inside the single-way valve 8, the O-ring 9 and the liquid outlet valve 11 are made of silicon, which has a good durability and a characteristic of automatic contraction.

Since the hexagonal screws 5 fix the liquid soap container 7 in the liquid soap dispenser 1, the liquid soap container 7 is protected from being taken away or damaged. In a preferred embodiment, a projection point of a tail of the screw 5 enters into the slot 6 to adjust an angle for controlling the squeezing strength and a return position.

The frame or plate printed with pattern or picture can be formed from plastic, metal, glass, wood, ceramic, fiber, stone, shell, cardboard, PU, PVC or leather.

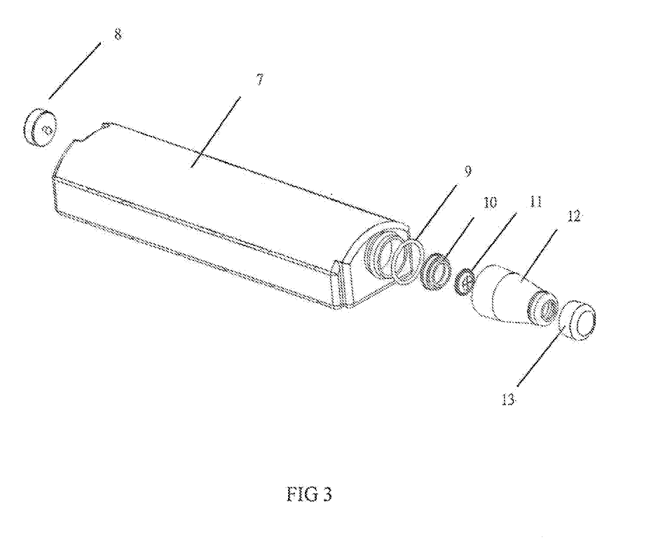

As illustrated in FIG. 3, the single-way valve 8 is mounted at the rear end of the liquid soap container 7 so as to help the outflow of liquid from the liquid soap container 7 more fluidly. At the front end opposite to the single-way valve 8, the container 7 connects with the nozzle 12 which contains the liquid outlet valve 11 connected with the liquid soap container 7, the O-ring 9 and the liquid outlet valve stabilizer 10. Preferably, the liquid soap container 7 has a smooth front face which is designed to be in the shape of an arch. With such design, the liquid soap container 7 will receive a pressure smoothly when a user presses the liquid squeezing box 3, and the liquid soap will outflow under a small pressure.

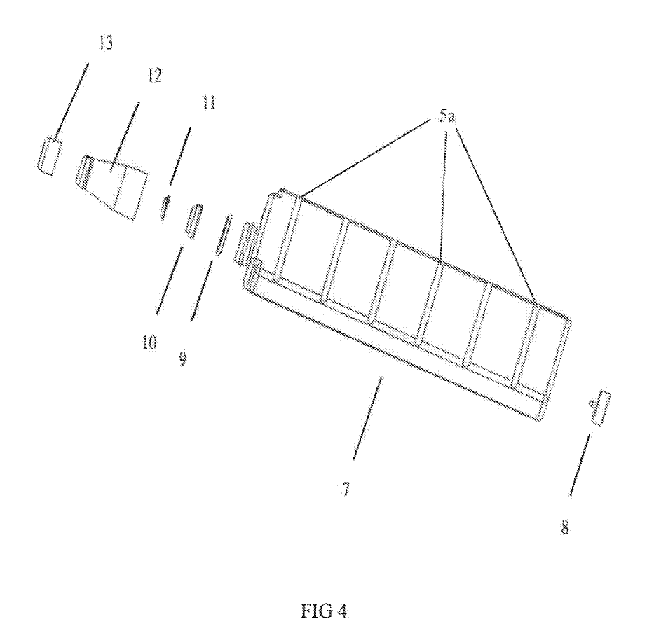

Referring to FIG. 4, in a preferred embodiment, several grooves 5a are provided at the back face of the liquid soap container 7 for strengthening purpose and to fit with two resting ridges 4a provided inside the bottom box 4 for holding the container 7. The resting ridges 4a are designed to hold the liquid soap container 7 in the housing assembly 2 steady, shakeless and the cooperation of the resting ridges 4a and the ridges inside the liquid squeezing box 3a can imitate the squeezing action by the fingers of a user from both sides and hence enabling uniform press of the liquid soap container 7.

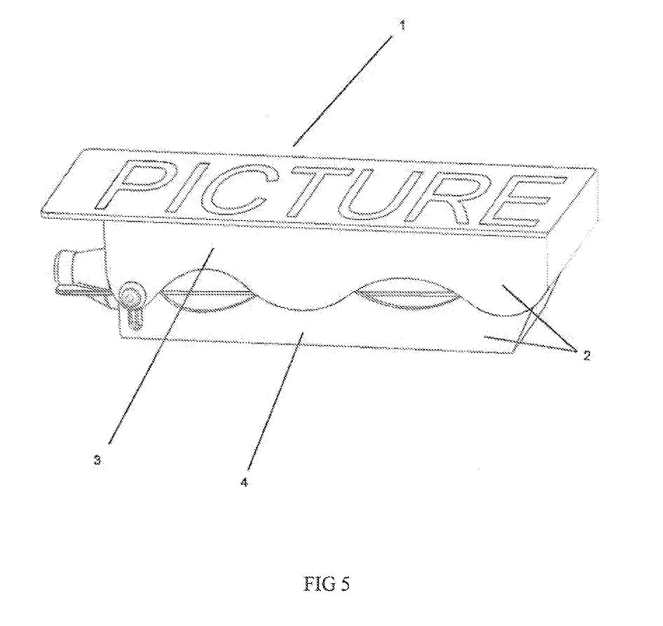

FIG. 5 illustrates an assembled liquid soap dispenser 1 according to present invention, which comprises a hollow housing assembly 2 which is combined by a liquid squeezing box 3 and a bottom box 4, and a picture or photo that prints pattern, character or commercial advertisement can be attached to the liquid squeezing box 3.

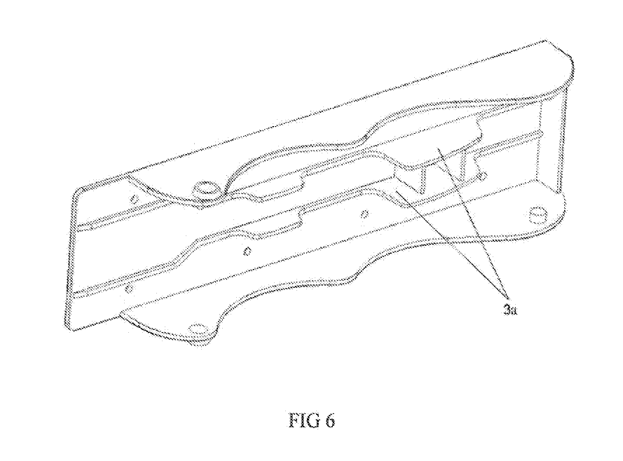

As illustrated in FIG. 6, in a preferred embodiment, a protruding squeezing ridges 3a is formed inside the liquid squeezing box 3, when the liquid squeezing box 3 is squeezed, the squeezing ridges 3a apply a force on the liquid soap container 7 and deform it, and the liquid soap contained in the container 7 will flow out from an outlet at bottom.

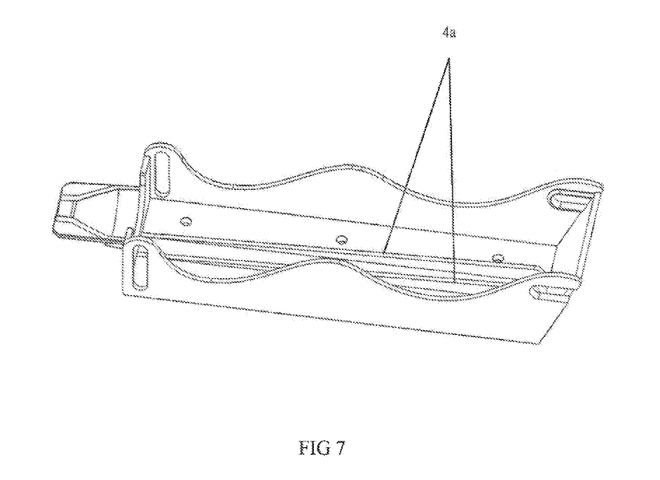

As shown in FIG. 7, two resting groove 4a are provided inside the bottom box 4 of the dispenser so as to engage with the liquid soap container 7, thus securing the liquid soap container 7 inside the housing 2. When the liquid squeezing box is pressed, the resting groove 4a helps to provide a uniform pressing force upon the liquid soap container 7 to deform it. As a consequence, the liquid soap is dispensed from outlet at bottom of the liquid soap container 7 smoothly.

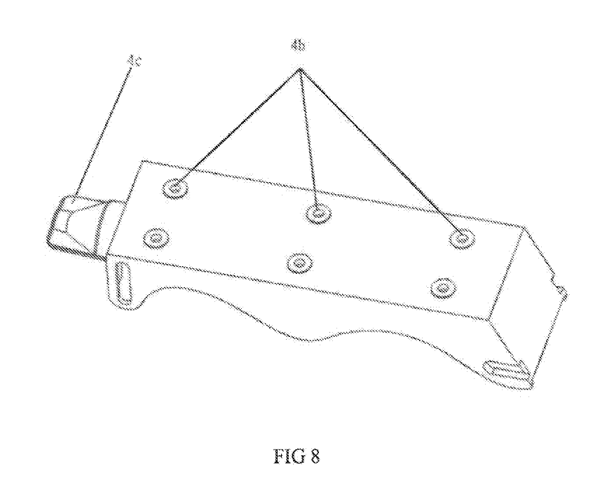

As illustrated in FIG. 8, in a preferred embodiment, the bottom box 4 of the liquid soap dispenser is provided with a plurality of holes 4b for fixing the dispenser on a wall by screws and a supporting bracket 4c is connected to one end of the bottom box to protect the nozzle from being yanked by human fingers.

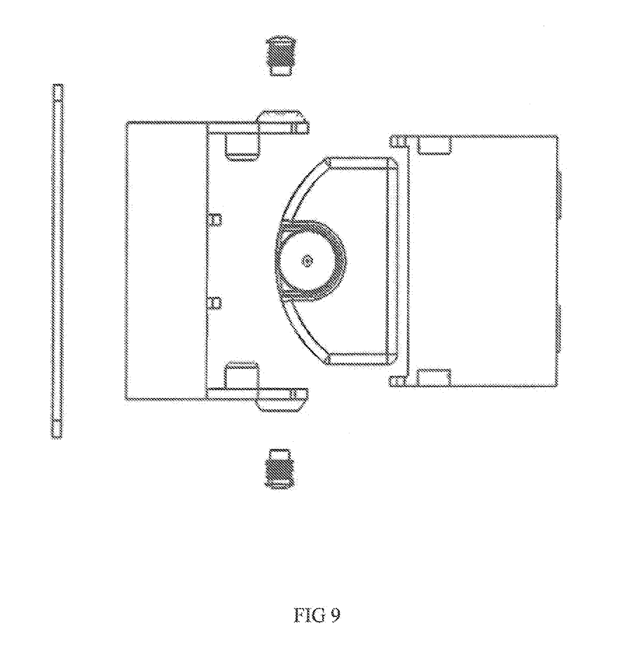

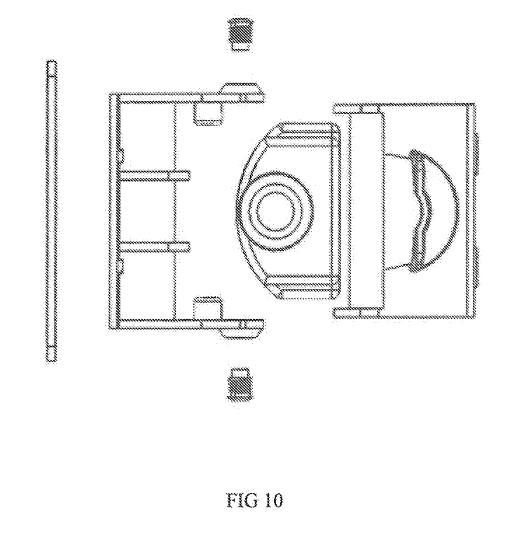

FIGS. 9 and 10 illustrate a top view and a bottom view of an embodiment of the liquid soap dispenser.

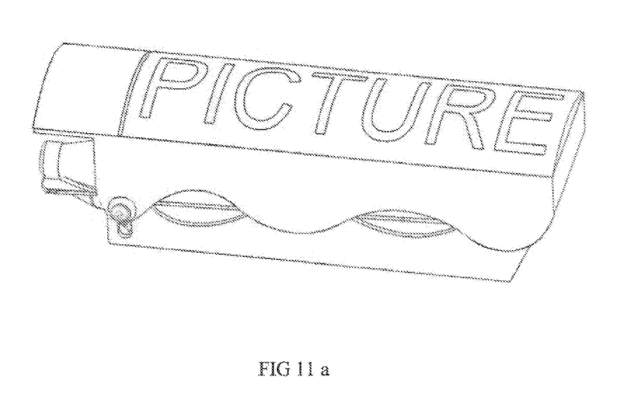

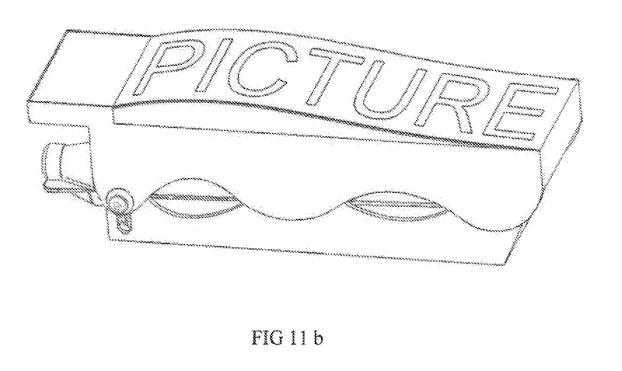

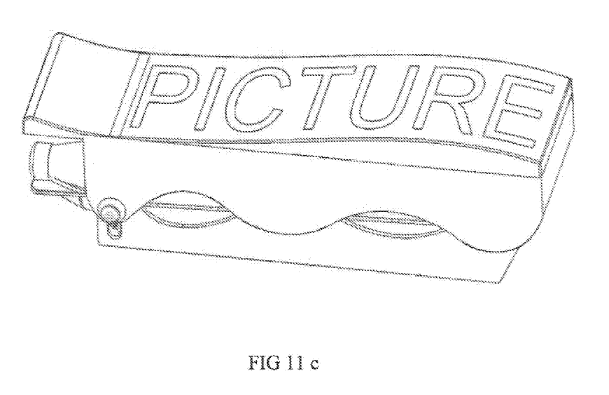

FIGS. 11a, 11b, 11c and 11d are schematic views of the liquid squeezing box of various arcuate designs.

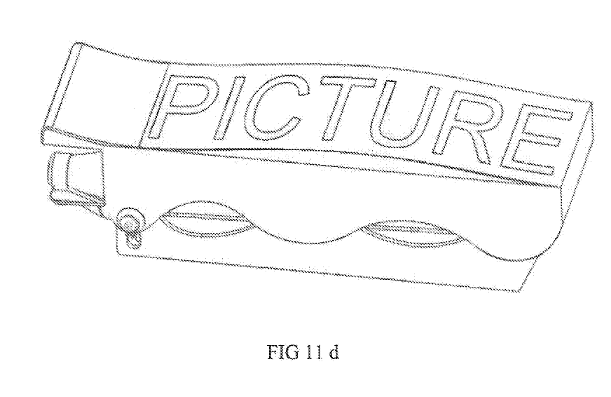

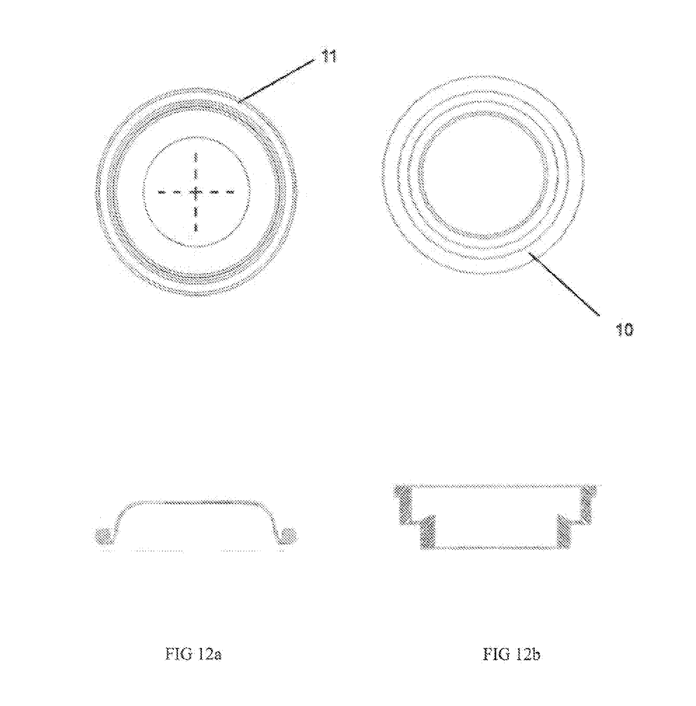

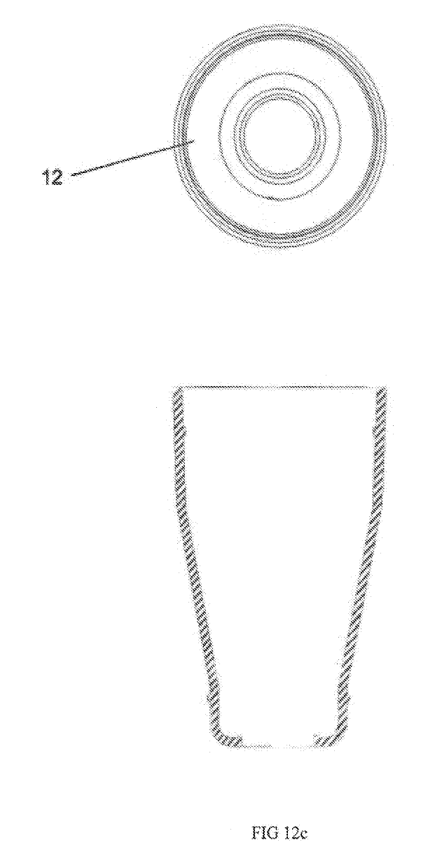

FIGS. 12a, 12b and 12c are top view and side view of the silicon liquid outlet valve, the liquid outlet valve stabilizer and the nozzle used in an embodiment of present invention.

1. A liquid soap dispenser, comprising:
a hollow housing assembly comprising a liquid squeezing box and a bottom box;
a liquid soap container disposed inside the housing;
a single-way valve mounted at the rear end of the liquid soap container;
a nozzle connected with the front end of the liquid soap container;
a liquid outlet valve disposed in the nozzle; and
a supporting bracket connected to one end of the bottom box to protect the nozzle from being yanked by human fingers,
wherein the liquid squeezing box has a frame or plate on which a pattern, picture or characters are printed; and
wherein the liquid squeezing box is connected to the bottom box by screws, so that the liquid squeezing box is replaceable.

2. The liquid soap dispenser according to claim 1, wherein the liquid squeezing box and the bottom box are made of plastic and are molded into a cuboid shape, wherein said screws are used to fix the liquid soap container in the liquid soap dispenser, a projection point of a tail of at least one said screw enters a slot of the liquid soap container to adjust an angle so as to control a squeezing strength and a return position, and wherein two inclined protruding squeezing ridges are provided inside the liquid squeezing box.

3. The liquid soap dispenser according to claim 1, wherein the liquid soap container has a smooth front face which is in the shape of an arch, and a back face of the liquid soap container is provided with grooves for strengthening, and fitting with two resting ridges provided inside the bottom box.

4. The liquid soap dispenser according to claim 2, wherein the frame or plate printed with the pattern, picture or characters is made from at least one material selected from the group consisting of plastic, metal, glass, wood, ceramic, stone, fiber, shell, cardboard, PU, PVC and leather.

5. The liquid soap dispenser according to claim 1, wherein the liquid squeezing box is formed with two holes, and the frame or plate printed with the pattern or picture and the liquid squeezing box are connected by two screws.

6. The liquid soap dispenser according to claim 1, wherein a liquid outlet valve stabilizer is mounted at the front end of the liquid soap container and arranged in front of said front end of the liquid soap container and said front end of the nozzle.

7. The liquid soap dispenser according to claim 6, wherein a silicon O-ring is disposed at the front end of the liquid soap container between the said container and the nozzle, so as to prevent leakage from the said position.

8. The liquid soap dispenser according to claim 6, wherein the nozzle is further provided with a protection cap at its front end.

9. The liquid soap dispenser according to claim 1, wherein different patterns, pictures and characters are interchangeable on the front of the liquid squeezing box.
